(19) United States
(12) Patent Application Publication
(10) Pub. No.: US 2004/0178888 A1
(43) Pub. Date: Sep. 16, 2004

(54) Bi-directional transfer of signals between a power line communication system and a coaxial distribution system

(75) Inventors: Jeffery Arnold Hales, Suwanee, GA (US); Gordon Thomas Mitchell, Duluth, GA (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(73) Assignee: coaXmedia, Inc., Duluth, GA

(21) Appl. No.: 10/798,671

(22) Filed: Mar. 11, 2004

Related U.S. Application Data
(60) Provisional application No. 60/455,075, filed on Mar. 14, 2003.

(51) Int. Cl. H04M 11/04

(52) U.S. Cl. 340/310.01

(57) ABSTRACT

A media converter for bridging or inter-connecting a power-line backhaul distribution (WAN) and coaxial (LAN) distribution within a Multi-Tenant Unit (“MTU”). The functions required to facilitate “converting” and transporting information between the power line distribution network and the coaxial distribution network would be contained within one or more (media converters).

This application claims priority to U.S. Provisional Patent Application Serial No. 60/455,075 filed Mar. 14, 2003 for Method for Providing Bi-directional Transfer of Signals to and from a Power Line Communication System and a Coaxial Distribution System.

### BACKGROUND

This invention is in the field of data communications. More specifically this application describes a communications path between power line communications (PLC) and coaxial communications distribution networks.

Distribution of high-speed information into a complex of buildings, such as a business, Multi-Dwelling Units or Hotels (all of these generally referred to as Multi-tenant Units or MTUs), can be problematic since the distribution of the high speed information is dependent on the quality and availability of the wiring infrastructure. Typically, these building will use twisted pair and/or coax wiring distribution methods; and in some case wireless. Although wireless technologies can help overcome some of the limitations of a poor, or degraded, wiring infrastructure, wireless is not yet view as a replacement for the typical distribution technologies, due to its own deployment limitations. For this reason, wireless solutions are viewed as being complementary to the use of the wired solutions. Out of all the current distribution technologies, using the coaxial network within the MTU provides the highest quality and the most robust bi-directional delivery of this information.

One of the keys to the successful bi-directional delivery of information in this environment is to provide one or more collection points (centralized or distributed) that can direct the flow of information to multiple subscribers (LAN side) from an external source. This external source of information can be provided to the Wide Area Network (WAN) side of the collection point(s) within the MTU via a number of backhaul transport technologies. These backhaul transport technologies typically consist of: fiber and twisted pair Telco connections, coaxial Cableco connections, and wireless connections, providing a high-speed conduit between the MTUs and external sources such as the Internet. But, with recent advancements in technologies, the single most pervasive wiring type of all can be utilized-power lines. Power line distribution systems extends inside and outside MTU environments, offering the potential to delivery high-speed information to any device that is plugged into a power outlet. However, power lines are one of the most difficult and harsh environment available for the delivery of high-speed information. Considering these issues and understanding how power is distributed inside and outside the MTUs and with the availability of coaxial wiring internal to the MTU, a combination of power line and coaxial distribution can provide a cost and performance effective solution for broadband deployment. Combining these two technologies to provide the “back-haul” distribution through the power line network and using the coax for in-building distribution offers a unique solution for the deployment of voice, video and data to subscribers.

### BRIEF SUMMARY OF THE DISCLOSURE

This disclosure describes a media converter for bridging or inter-connecting a power-line backhaul distribution (WAN) and coaxial (LAN) distribution within a MTU. The functions required to facilitate “converting” and transporting information between the power line distribution network and the coaxial distribution network would be contained within MTU collection point (media converter); and although only one collection point is presented in the FIG. 1 (discussed below), multiple collection points may be utilized to reach the desired number of subscriber locations.

These and other advantages of the present invention are apparent from the drawings and the detailed description that follows.

### BRIEF DESCRIPTION OF THE DRAWING

FIG. 1 shows one embodiment of the present invention in a hybrid power line communications (PLC) and coaxial communications distribution network.

### DETAILED DESCRIPTION OF THE ENCLOSED EMBODIMENT

The present invention will now be described more fully hereinafter with reference to the accompanying drawings, in which preferred embodiments of the invention are shown.

This invention may, however, be embodied in many different forms and should not be construed as limited to the embodiments set forth herein; rather, these embodiments are provided so that this disclosure will be thorough and complete, and will fully convey the scope of the invention to those skilled in the art.

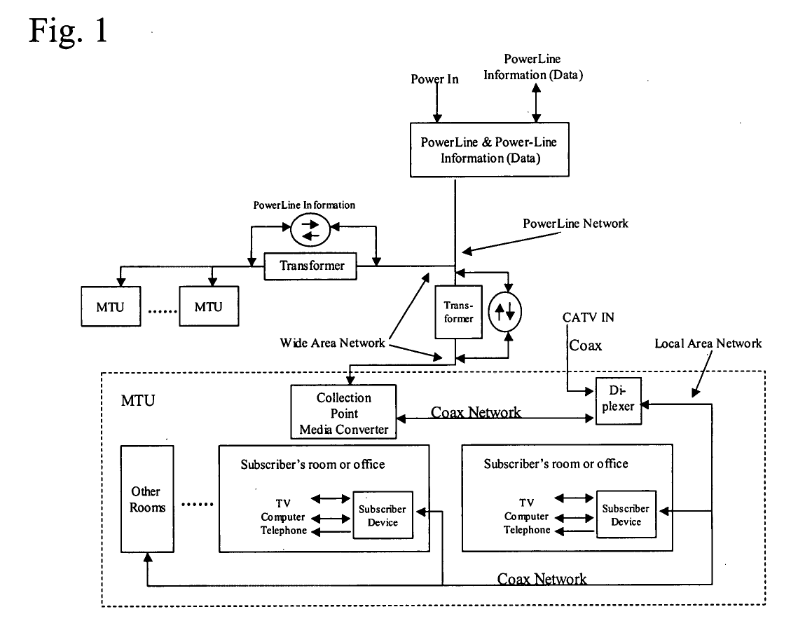

FIG. 1 shows the use of a media converter for bridging or inter-connecting a power-line backhaul distribution (WAN) and coaxial (LAN) distribution within a MTU. The functions required to facilitate “converting” and transporting information between the power line distribution network and the coaxial distribution network would be contained within MTU collection point (media converter); and although only one collection point is presented in the FIG. 1, multiple collection points may be utilized to reach the desired number of subscriber locations. The collection point device or media converter may also provide any number of management options to simplify the overall system operation and maintenance.

It should also be noted, that although the typically utilization of this new device or system supports a power-line external source(s) and multiple coaxial based subscribers, the device can be utilized to service multiple power-line subscribers from a coaxial sources.

Those skilled in the art will recognize that the methods and apparatus of the present invention have many applications and that the present invention is not limited to the specific examples given to promote understanding of the present invention. Moreover, the scope of the present invention covers the range of variations, modifications, and substitutes for the system components described herein, as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

We claim:

1. A system with a bi-directional bridge (media converter) between a Power Line Communications (PLC) based network and a coaxial based network wherein the PLC side provides the Wide Area Network connection and the coaxial side provides a Local Area Network connection and bi-directional bridge allows the bi-directional transport of standard media protocols from the high or medium voltage Wide Area Network side to low voltage requirements of the coaxial networks.

2. The system with the bi-directional bridge of claim 1 wherein RF signals containing the standard media protocols are conveyed over the PLC based networks to a media converter located associated with a building with at least one dwelling unit.

3. The system with the bi-directional bridge of claim 2 further comprising at least one additional media converter to allow the extension of the Wide Area Network to support the deployment of broadband services across a physically dispersed area without the requirement for separate and unique Wide Area Network connections.
